(19) United States
(12) Patent Application Publication
(10) Pub. No.: US 2009/0319239 A1
(43) Pub. Date: Dec. 24, 2009

(54) TOPOLOGY MODELING APPLICATION THAT HANDLES ABSTRACT ENTITIES THROUGH THE REALIZATION OF CONCEPTUAL OBJECTS

(75) Inventors: WILLIAM C. ARNOLD, MAHOPAC, NY (US); DANIEL C. BERG, HOLLY SPRINGS, NC (US); BRAD L. BLANCETT, RALEIGH, NC (US); TAMAR EILAM, NEW YORK, NY (US); MICHAEL D. ELDER, DURHAM, NC (US); CHAD M. HOLLIDAY, HOLLY SPRINGS, NC (US); MICHAEL H. KALANTAR, CHAPEL HILL, NC (US); ALEXANDER V. KONSTANTINOU, NEW YORK, NY (US); NARINDER MAKIN, MORRISVILLE, NC (US); TIMOTHY A. POUYER, GREENVILLE, SC (US); EDWARD C. SNIBLE, BRONX, NY (US); JOHN E. SWANKE, TERRYVILLE, CT (US); ALEXANDER A. TOTOK, NEW YORK, NY (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, Armonk, NY (US)

(21) Appl. No.: 12/141,655

(22) Filed: Jun. 18, 2008

(51) Int. Cl. G06G 7/48; G06N 5/02

(52) U.S. Cl. 703/6

(57) ABSTRACT

The present invention can include a solution for handling abstract entities through the realization of conceptual objects within a modeling application. Such a system can include a semantic model and a modeling application. The semantic model can be configured to present relationships between entities. The entities can include both conceptual objects and concrete objects. A conceptual object can represent an abstract definition that can contain unfulfilled functional parameters. The conceptual object can be associated with another conceptual object or concrete object using a realization relationship. The modeling application can be configured to handle conceptual objects and realization relationships, while preserving the relational integrity of the semantic model.

### BACKGROUND OF THE INVENTION

The present invention relates to the field of topological modeling using software, and, more particularly, to handling abstract entities by realizing conceptual objects within a topology modeling application.

Modeling applications are popular tools for developing semantic models that are used across a wide variety of disciplines. Generally, a modeling application includes a multitude of objects and relationships representing the various elements of the model, such as the computing devices and communication pathways of a network topology.

Conventional modeling applications strictly enforce object definitions within the semantic model. This rigidity is in sharp contrast to the fluidity of the development process, where implementation details and functionality parameters are often unknown until much later in the process. Therefore, a user cannot create an abstract definition of an object containing unfulfilled functional parameters within a semantic model using conventional modeling applications.

Attempts to work around this obstacle typically require the user to fill the object with fake parameters and/or data. This approach requires the user to remember to modify these fake data items to contain real data when it becomes available and to communicate the falsities to other users utilizing the semantic model. Further, the use of such fake data items causes processing problems for the modeling engine of the modeling application.

### BRIEF SUMMARY OF THE INVENTION

The present invention can be implemented in accordance with numerous aspects consistent with the materials presented herein. One aspect of the present invention can include a system for handling abstract entities through the realization of conceptual objects within a modeling application. Such a system can include a semantic model and a modeling application. The semantic model can be configured to present relationships between entities. The entities can include both conceptual objects and concrete objects. A conceptual object can represent an abstract definition that can contain unfulfilled functional parameters. The conceptual object can be associated with another conceptual object or concrete object using a realization relationship. The modeling application can be configured to handle conceptual objects and realization relationships, while preserving the relational integrity of the semantic model.

Another aspect of the present invention can include a method for handling abstract entities through the realization of conceptual objects within a modeling application. A realization relationship of a semantic model can be identified within a modeling application. The realization relationship can be between a conceptual object and a target object, where the target object can be another conceptual object or concrete object. The conceptual object can represents an abstract definition containing unfulfilled functional parameters. The realization relationship can then be processed. When the realization relationship is able to be thoroughly processed, the conceptual object can be semantically folded into the target object, such that the target object encompasses the unfulfilled functional parameters of the conceptual object.

Still another aspect of the present invention can include a semantic model that incorporates abstract entities using realization relationships. Such a semantic model can contain conceptual objects, concrete objects, and realization relationships. The conceptual object can be configured to represent an abstract entity within the semantic model that can contain unfulfilled functional parameters. The concrete object can be configured to represent an absolute entity within the semantic model with all functional parameters fulfilled. The realization relationship can associate an originating object with a target object. The originating object can be a conceptual object, while target object can be another conceptual object or a concrete object. The target object can fulfill one or more of the unfulfilled functional parameters of the originating object.

### BRIEF DESCRIPTION OF THE SEVERAL VIEWS OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for handling abstract entities through the realization of conceptual objects within a modeling application in accordance with embodiments of the inventive arrangements disclosed herein.

FIG. 2 is a schematic diagram of a sample semantic model illustrating the realization of conceptual objects in accordance with an embodiment of the inventive arrangements disclosed herein.

FIG. 3 is a schematic diagram of another sample semantic model illustrating the realization of conceptual objects in accordance with an embodiment of the inventive arrangements disclosed herein.

FIG. 4 is a collection of semantic models of topologies illustrating the semantic folding of conceptual objects in accordance with an embodiment of the inventive arrangements disclosed herein.

### DETAILED DESCRIPTION OF THE INVENTION

The present invention discloses a solution that can handle abstract entities of a semantic model through the realization of conceptual objects within a modeling application. A conceptual object can be defined within the modeling application with parameters that are unfulfilled. Fulfillment of these parameters can be realized by a target object related to the conceptual object via a realization relationship. Through a chain of one or more conceptual objects connected with realization relationships, a conceptual object can be realized into a concrete object within the semantic model.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

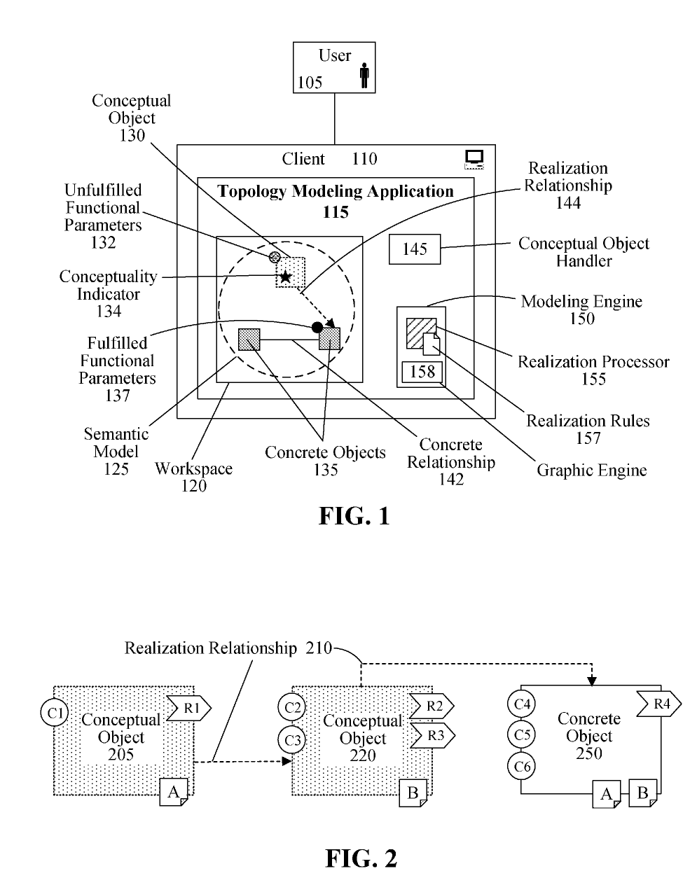

FIG. 1 is a schematic diagram illustrating a system 100 for handling abstract entities through the realization of conceptual objects 130 within a modeling application 115 in accordance with embodiments of the inventive arrangements disclosed herein. In system 100, a user 105 can utilize the modeling application 115 running on a client device 110 to create a semantic model 125 containing conceptual objects 130 and realization relationships 144.

The semantic model 125 can graphically represent a physical system for the purposes of development and implementation. Representation of a physical system within the semantic model 125 can include conceptual objects 130, concrete objects 135, concrete relationships 142, and realization relationships 144.

A conceptual object 130 can represent an abstract and/or partial definition of an entity of the physical system being represented. That is, the conceptual object 130 can exist within the semantic model 125 as a preliminary placeholder that has yet to be fully defined. This abstract or partial definition can be represented by one or more unfulfilled functional parameters 132 contained within the conceptual object 130. The unfulfilled functional parameters 132 can include a variety of definition elements supported by the modeling application 115, such capabilities, requirements, and constraints of the object 130.

For example, in the initial development stage of a computer network, only a few, basic parameters 132 may be known for a server, such as the type of application being hosted and memory required. Later in the development, a conceptual object 130 representing this server can be realized by a concrete object 135 that represents an actual, physical server in the network.

In another example, only a few capabilities may be known for a server, such as the operating system capability of the server. Later in the development process, the server may be realized by a LINUX OS unit with several capabilities including XEN HYPERVISOR, etc., and specific hosting requirements. Thus, the unfulfilled elements 132 of a conceptual unit 130 as presented herein can include variable structural elements as well as variable elements for attributes.

The concrete object 135 can represent object types that can be already available within the modeling application 115 and can contain fulfilled functional parameters 137 representing defined conditions, such as an amount of available memory. These fulfilled functional parameters 137 can encompass all of the unfulfilled functional parameters 132 of any connected conceptual objects 130. Thus, a concrete object 135 can be a final representation of one or more related conceptual objects 130. Following the previous example, a defined database server 135 can be used to realize two different conceptual database objects 130.

The conceptual 130 and concrete objects 135 can be related with each other via various relationships 142 and 144. Concrete relationships 142 can represent the types of relationships between concrete objects 135 that can be typically found in modeling applications 115, such as associations and hosting links.

Conceptual objects 130 can utilize a realization relationship 144 to be connected with another conceptual 130 or concrete object 135. The realization relationship 144 can express that all or part of the originating object can be realized by the target object.

It is important to note the relational functionality of conceptual objects 130. Since a conceptual object 130 exists as an abstract entity with unfulfilled parameters 132, it cannot be related using any type of concrete relationship 142. Instead, the conceptual object 130 can be realized or made concrete through a chain of one or more realization relationships 144. Even if a conceptual object 130 is realized by a secondary conceptual object 130, that secondary conceptual object 130 must eventually be realized by a concrete object 135. Thus, all conceptual objects 130 can eventually be represented by concrete objects 135. Additionally, realization relationships 144 can be used to connect a concrete object 135 to another concrete object 135 or conceptual object 130.

The modeling application 115 can be similar to a variety of commercially available software applications designed for the creation and/or manipulation of semantic models 125. The modeling application 115 of system 100 can further include a conceptual object handler 145 and a modeling engine 150.

The conceptual object handler 145 can represent a component of the modeling application 115 configured to support functionality for creating and/or modifying conceptual objects 130 and realization relationships 144. The creation of conceptual objects 130 can include the use of a conceptuality indicator 134.

When the user 105 adds a generic object to the semantic model 125 within the workspace 120, the object can be specified as a conceptual object 130 via the selection of the conceptuality indicator 134. The conceptuality indicator 134 can be implemented within the modeling application 115 in a variety of manners, including, but not limited to, a BOOLEAN variable, a checkbox, a radio button, an object property, and the like.

The modeling engine 150 can represent the algorithms used to process the semantic model 125 and perform modeling functions, such as semantic folding of objects. The modeling engine 150 of the modeling application 115 can contain a realization processor 155. The realization processor 155 can be a component of the modeling engine 150 configured to handle the realization relationships 144 of conceptual objects 130.

Processing of realization relationships 144 by the realization processor 155 can include use of a set of realization rules 157 for validation. Realization rules 157 can be based on a variety of premises, such as object type or subtype relational compatibility and the satisfaction of unfulfilled parameters 132. Further, the modeling application 115 can be configured to allow the addition of user-defined realization rules 157. These rules may be contributed locally or may reside in an external repository (e.g., CMDB, RAM, etc.).

The graphical engine 158 can graphically render a semantic model 125 and can graphically express relationships 144 among conceptual objects 130 and/or concrete objects 135. The modeling application 115 can perform model level programmatic actions irrespective of a graphical tool, such as optional graphical engine 158. In one embodiment, the modeling application 115 can be designed to interface semantic models 125 with an external graphical tool implemented independent of application 115, which may reside on a device external to client 110. In another example, the topology modeling application 115 can be a graphical modeling application that internally implements a graphical engine 118.

FIG. 2 is a schematic diagram of a sample semantic model 200 illustrating the realization of conceptual objects in accordance with an embodiment of the inventive arrangements disclosed herein. Semantic model 200 can be utilized within the context of system 100 or any other system that supports the realization of conceptual objects within a semantic model.

Semantic model 200 can include conceptual objects 205 and 220 that can be related to a concrete object 250 via realization relationships 210. The semantic model 200 can be read as conceptual object 205 is realized by conceptual object 220, which is realized by concrete object 250.

In this example, conceptual object 205 can include capability C1, requirement R1, and constraint A. Conceptual object 220 can include capabilities C2 and C3, requirements R2 and R3, and constraint B. These conceptual objects 205 and 220 can represent two sets of functional parameters for the same concrete object 250.

For example, the finance department can specify that they need a restricted-access (constraint A) server 205 having a database (R1) to run a financial projection application (C1). The information technology (IT) department can further specify that the server 220 adhere to security protocols (C2) and backup procedures (C3) while not exceeding storage or memory resources (R2 and R3) and without purchasing new hardware (constraint B).

The concrete object 250 can represent the physical machine that can satisfy all of these functional parameters. It should be noted that a one-to-one correlation of functional parameters need not exist between the two objects related by a realization relationship 210; only that the concrete object 250 satisfy the functional parameters of any related conceptual objects 205 and 220.

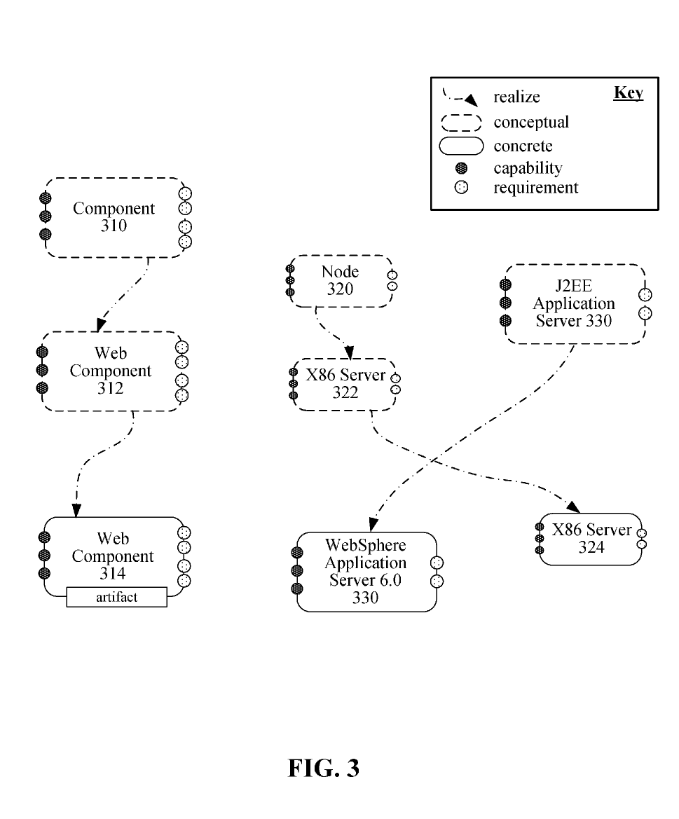

FIG. 3 is a schematic diagram of another sample semantic model 300 illustrating the realization of conceptual objects in accordance with an embodiment of the inventive arrangements disclosed herein. Semantic model 300 can be utilized within the context of system 100 or any other system that supports the realization of conceptual objects within a semantic model.

Semantic model 300 shows a number of conceptual objects 310, 312, 320, 322, and 330 that are realized as concrete objects 314, 324, 332 as shown. Each of the objects 310-332 can include numerous capabilities and requirements.

More specifically, model 300 is a subtype illustration where a relation between types of realized objects 310-332 is a subtype relationship. As shown, component 310 can be realized as a Web component 312, which can be realized as a concrete Web component 314. Node 320 can be realized as an X86 server 322, which can be realized as X86 server 326. J2EE application server 330 can be realized as a WEBSPHERE APPLICATION SERVER 332.

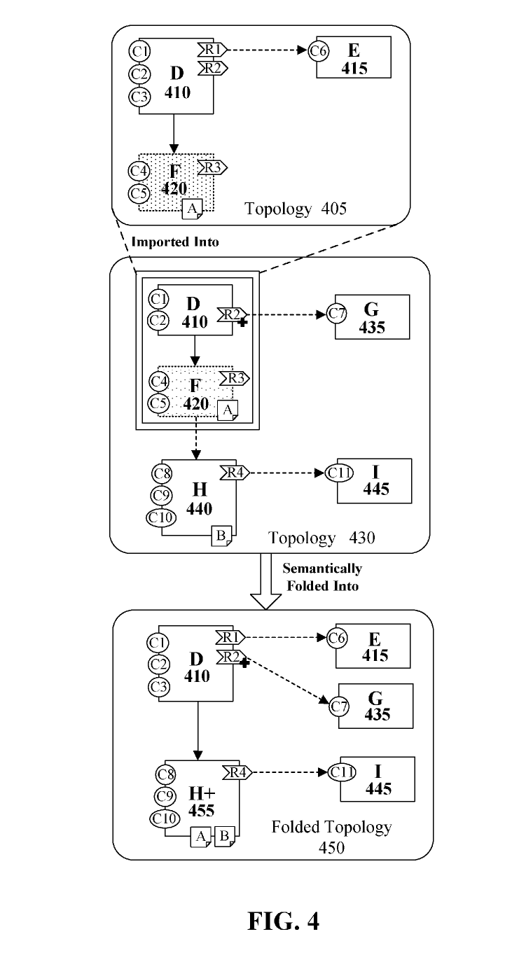

FIG. 4 is a collection 400 of semantic models of topologies 405, 430, and 450 illustrating the semantic folding of conceptual objects in accordance with an embodiment of the inventive arrangements disclosed herein. Within the topologies 405, 430, and 450 of collection 400, concrete objects are represented by the gray boxes with solid outlines while conceptual objects are represented by the speckled boxes with dotted outlines. Also, realization relationships are represented by dotted arrow lines while concrete relationships are represented by solid arrow lines

In topology 405, object D 410 can include capabilities C1, C2, and C3, and requirements R1 and R2. Requirement R1 can be realized by capability C6 of object E 415. Object D 410 can be concretely related to the conceptual object F 420. Object F 420 can include capabilities C4 and C5, requirement R3, and constraint A. In topology 405, object F 420 is unrealized. To realize object F 420, topology 405 can be imported into topology 430.

In topology 430, requirement R2 of object D 410 can be realized by capability C7 of object G 435. The conceptual object F 420 can be realized by the concrete object H 440. Object H 440 can include capabilities C8, C9, and C10, requirement R4, and constraint B. Requirement R4 of object H 440 can be realized by capability C11 of object 1445.

The semantic folding of topologies 405 and 430 can result in folded topology 450. It is important to note that the folded topology 450 contains only concrete objects. That is, the conceptual object F 420 has been realized by its target concrete object H+ 455. Unlike object H 440 of topology 430, object H+ 455 includes the constraint A from object F 420. All other relationships can remain unchanged.

It should be noted that the importance of the folded topology view is that validation and resolution logic can operate over that view without having to worry about realization chains and the like. In other words, the folded topology view is a mechanism for scaling model-driven design platforms.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system for handling abstract entities through the realization of conceptual objects within a topology modeling application comprising:
a semantic model configured to present relationships between a plurality of entities, wherein the plurality of entities comprises at least one conceptual object and at least one concrete object, wherein the at least one conceptual object is associated with one of a secondary conceptual object and a concrete object using a realization relationship, and, wherein the at least one conceptual object represents an abstract definition of an entity containing at least one unfulfilled functional parameter; and
a modeling application configured to handle the at least one conceptual object and the realization relationship of the semantic model, wherein a relational integrity of the semantic model is preserved.

2. The system of claim 1, wherein the modeling application further comprises:
a conceptual object handler configured to support a usage of the at least one conceptual object and the realization relationship by the modeling application for creating the semantic model; and
a modeling engine configured to process the at least one conceptual object and the realization relationship of the semantic model to produce a final concrete semantic model, wherein the at least one conceptual object of the semantic model is realized into a corresponding concrete object within the final concrete semantic model, whereby the final concrete semantic model resolves all unfulfilled functional parameters of all conceptual objects contained within the semantic model.

3. The system of claim 2, wherein the modeling engine further comprises:
a realization processor configured to evaluate the realization relationship utilizing a plurality of realization rules, wherein said evaluation ensures that a target entity of the realization relationship encompasses at least one of the at least one unfulfilled functional parameters of an originating conceptual object.

4. The system of claim 3, wherein the plurality of realization rules comprises at least one of an object type compliance, a capabilities satisfaction, a requirements satisfaction, a constraint satisfaction, and a realization fulfillment.

5. The system of claim 2, wherein the modeling engine produces the final concrete semantic model utilizing semantic folding.

6. The system of claim 5, wherein the modeling engine is configured to provide at least one folded view when utilizing semantic folding, wherein the modeling application is configured to exposed the at least one folded view to consumers for purposes including validation and resolution.

7. The system of claim 1, wherein the at least one unfilled parameter comprises at least one of a constraint, a requirement, and a capability.

8. The system of claim 1, wherein an entity of the semantic model is identified within the modeling application as a conceptual object using a conceptuality indicator, wherein a presence of the conceptuality indicator within the entity allows a creation of the at least one unfilled parameter, wherein said creation is forbidden within the at least one concrete object.

9. The system of claim 8, wherein the conceptuality indicator is represented by a user-selectable BOOLEAN variable within the modeling application.

10. A method for handling abstract entities through the realization of conceptual objects within a modeling application comprising:
identifying at least one realization relationship of a semantic model presented within a modeling application, wherein the at least one realization relationship is between a conceptual object and a target object, wherein the target object is one of a secondary conceptual object and a concrete object, and, wherein the conceptual object represents an abstract definition of an entity containing at least one unfulfilled functional parameter;
processing the at least one realization relationship; and
when the at least one realization relationship is thoroughly processed, semantically folding the conceptual object into the target object, wherein the target object encompasses at least one of the at least one unfulfilled functional parameters of the conceptual object.

11. The method of claim 10, wherein the processing step further comprises:
validating the realization relationship against a plurality of realization rules that define a proper usage of the realization relationship within the semantic model.

12. The method of claim 11, wherein the plurality of realization rules comprises at least one of an object type compliance, a capabilities satisfaction, a requirements satisfaction, a constraint satisfaction, and a realization fulfillment.

13. The method of claim 11, further comprising:
when the realization relationship is unable to be thoroughly processed, visually presenting a graphical identifier upon the realization relationship within the modeling application, wherein the graphical identifier signifies incomplete processing of the realization relationship.

14. The method of claim 13, wherein the incomplete processing of the realization relationship is caused by at least one of an existence of at least one unfulfilled parameter within the target object, and an violation of a realization rule

15. The method of claim 10, wherein the processing step is performed by a realization processor, wherein the realization processor is a component of a modeling engine of the modeling application.

16. The method of claim 10, the at least one unfilled parameter comprises at least one of a constraint, a requirement, and a capability.

17. A semantic model that incorporates abstract entities using realization relationships comprising:
at least one conceptual object configured to represent an abstract entity of a semantic model containing at least one unfulfilled functional parameter;
at least one concrete object configured to represent an absolute entity of the semantic model, wherein all functional parameters of the at least one concrete object are fulfilled; and
at least one realization relationship associating an originating object with a target object, wherein the originating object is the at least one conceptual object and the target object comprises at least one of a secondary conceptual object and a concrete object, wherein the target object fulfills at least one of the at least one unfulfilled functional parameters of the originating object.

18. The semantic model of claim 17, wherein the elements of claim 17 are created within a modeling application, wherein the modeling application is configured to handle said elements of claim 17.

19. The semantic model of claim 18, wherein the at least one conceptual object is created within the modeling application using a conceptuality indicator, wherein a presence of the conceptuality indicator allows a creation of the at least one unfilled parameter within the at least one conceptual object, wherein said creation is forbidden within the at least one concrete object.

20. The semantic model of claim 17, wherein the at least one unfilled parameter comprises at least one of a constraint, a requirement, and a capability.
